(19) United States
(12) Patent Application Publication
(10) Pub. No.: US 2016/0087910 A1
(43) Pub. Date: Mar. 24, 2016

(54) COMPUTING MIGRATION SPHERE OF WORKLOADS IN A NETWORK ENVIRONMENT

(71) Applicant: CISCO TECHNOLOGY, INC., San Jose, CA (US)

(72) Inventors: Shailesh Mittal, Santa Clara, CA (US); Raghu Krishnamurthy, Santa Clara, CA (US)

(73) Assignee: CISCO TECHNOLOGY, INC., San Jose, CA (US)

(21) Appl. No.: 14/492,313

(22) Filed: Sep. 22, 2014

(51) Int. Cl. H04L 12/911; H04L 29/08

(52) U.S. Cl. CPC H04L 47/70; H04L 67/32

(57) ABSTRACT

An example method for computing migration sphere of workloads in a network environment is provided and includes receiving, at a virtual appliance in a network, network information from a plurality of remote networks, analyzing a service profile associated with a workload to be deployed in one of the remote networks and indicating compute requirements and storage requirements associated with the workload, and generating a migration sphere comprising compute resources in the plurality of networks that meet at least the compute requirements and storage requirements associated with the workload, the workload being successfully deployable on any one of the compute resources in the migration sphere.

### TECHNICAL FIELD

This disclosure relates in general to the field of communications and, more particularly, to computing migration sphere of workloads in a network environment.

### BACKGROUND

Data centers are increasingly used by enterprises for effective collaboration and interaction and to store data and resources. A typical data center network contains myriad network elements, including hosts, load balancers, routers, switches, etc. The network connecting the network elements provides secure user access to data center services and an infrastructure for deployment, interconnection, and aggregation of shared resource as required, including applications, hosts, appliances, and storage. Improving operational efficiency and optimizing utilization of resources in data centers are some of the challenges facing data center managers. Data center managers want a resilient infrastructure that consistently supports diverse applications and services and protects the applications and services against disruptions. A properly planned and operating data center network provides application and data integrity and optimizes application availability and performance.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system for computing migration sphere of workloads in a network environment;

FIG. 2 is a simplified block diagram illustrating example details of embodiments of the communication system;

FIG. 3 is a simplified-flow diagram illustrating example operations that may be associated with an embodiment of the communication system; and

FIG. 4 is a simplified flow diagram illustrating other example operations that may be associated with an embodiment of the communication system.

### DETAILED DESCRIPTION OF EXAMPLE EMBODIMENTS

### Overview

An example method for computing migration sphere of workloads in a network environment is provided and includes receiving, at a virtual appliance in a network, network information from a plurality of remote networks, analyzing a service profile associated with a workload to be deployed in one of the remote networks and that indicates compute requirements and storage requirements associated with the workload, and generating a migration sphere comprising compute resources in the plurality of networks that meet at least the compute requirements and storage requirements associated with the workload, the workload being successfully deployable on any one of the compute resources in the migration sphere.

As used herein, the term “workload” refers to an independent service or collection of software code (e.g., forming a portion of an application) executing in a network environment. Workloads can include an entire application, or separate self-contained, independent subset of applications. Examples of workloads include client-server database applications, web server based n-tier applications, file and print servers, virtualized desktops, mobile social apps, gaming applications executing in cloud networks, hypervisors, batch-processing services of a specific application, reporting portion of a web application, etc.

### Example Embodiments

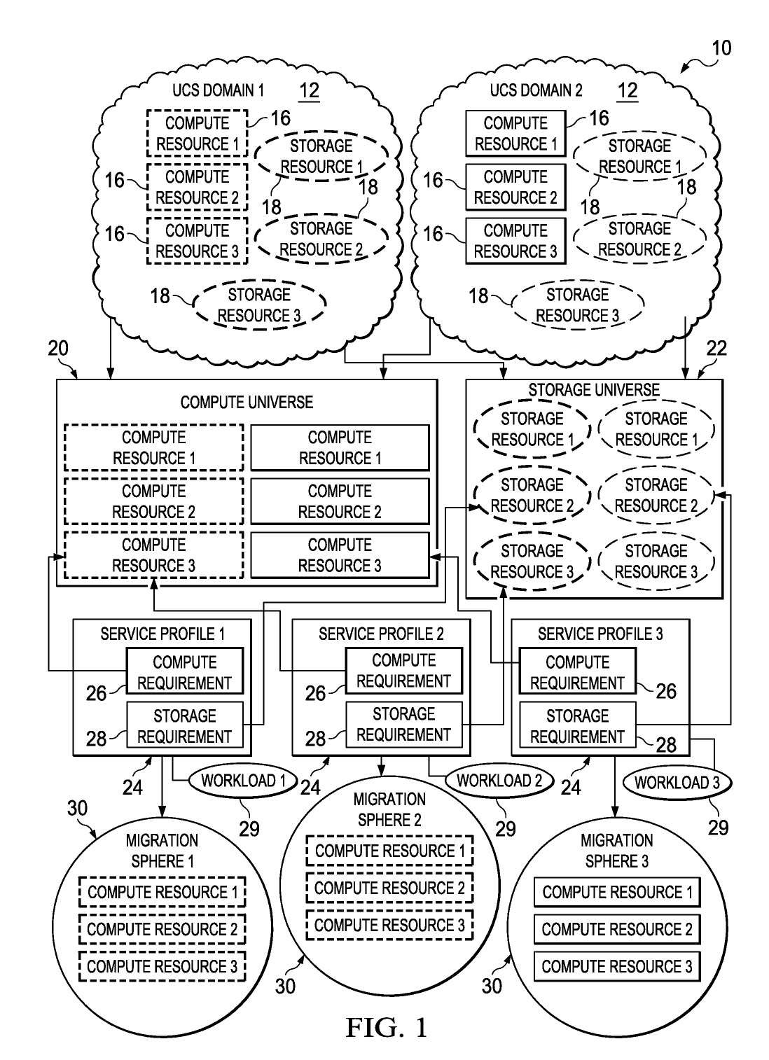

Turning to FIG. 1, FIG. 1 is a simplified block diagram illustrating a communication system 10 for computing migration sphere of workloads in a network environment in accordance with one example embodiment. FIG. 1 illustrates a communication system 10 comprising a plurality of networks 12 remote from each other, and each of which includes a plurality of compute resources 16 and storage resources 18. As used herein, the term “compute resource” includes any hardware computing device (e.g., server), including processors, capable of executing workloads; the term “storage resource” includes any hardware device (e.g., network attached storage (NAS) drives, computer hard disk drives), capable of storing data.

Each network 12 may be remote from other networks 12 in the sense that storage resources 18 in any one network 12 cannot be accessed by compute resources 16 in another network 12. The term “remote” is used in this Specification in a logical sense, rather than a spatial sense. For example, a rack of server blades and storage blades in a data center may comprise one network; and an adjacent rack of server blades and storage blades in the data center may comprise another network. In a general sense, communication between networks 12 may be through routers (e.g., at Layer 3 of the Open Systems Interconnect (OSI) network model), whereas communication within networks 12 may be through switches (e.g., at Layer 2 of the OSI network model). Additionally, each network 12 may be managed by separate instances of a management application referred to herein as unified computing system manager (UCSM), and each such network 12 may be called a UCS domain generally.

Compute resources 16 and storage resources 18 may be aggregated separately into a “compute universe” 20 and a “storage universe” 22 comprising respective lists of compute resources 16 and storage resources 18 in networks 12. In various embodiments, one or more service profile 24 may be generated and may include respective certain compute requirements 26 and storage requirements 28. As used herein, the term “service profile” encompasses a logical server definition, including server hardware identifiers, firmware, state, configuration, connectivity, behavior that is abstracted from physical servers on which the service profile may be instantiated. Compute requirements 26 and storage requirements 28 specify certain hardware requirements for compute resources 16 on which service profile 24 can be instantiated. In other words, service profile 24 is instantiated on only those compute resources 16 that can satisfy the corresponding compute requirements 26 and storage requirements 28.

In various embodiments, one or more workload(s) 29 may be deployed in networks 12 to respective service profiles 24. As examples and not as limitations, a specific workload 1 may be associated with service profile 1; another workload 2 may be associated with service profile 2; yet another workload 3 may be associated with service profile 3; and so on. For example, workload 1 may comprise a database application, requiring a 64 bit processor and an expandable RAID data storage; service profile 1 may include compute requirements of a 64 bit processor and an expandable redundant array of independent disks (RAID) storage; service profile 2 may include compute requirements of a 32 bit processor and a FC storage; therefore, workload 1 may be associated with service profile 1 rather than service profile 2.

In various embodiments, compute resources 16 may be grouped into migration spheres 30 according to service profile 24 and other network requirements, such that associated workload 29 may be deployable on any one of compute resources 16 in associated migration sphere 30. For example, workload 1 may be deployable on any compute resource 16 in migration sphere 1 (but not in migration sphere 2 or migration sphere 3); workload 2 may be deployable on any compute resource 16 in migration sphere 2 (but not in migration sphere 1 or migration sphere 3); etc. In other words, migration sphere 30 includes a list of substantially all compute resources 16 can be used to migrate a specific workload 29 associated with particular hardware specifications, including compute specifications (e.g., processor speed, type, power, etc.), storage specifications (e.g., connectivity, type, size, etc.), and network connectivity.

For purposes of illustrating the techniques of communication system 10, it is important to understand the communications that may be traversing the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

Enterprise workloads are traditionally designed to run on reliable, enterprise-grade hardware, where the underlying servers and storage are expected to not fail during normal course of operations. Complex enterprise technologies such as network link aggregation, storage multipathing, virtual machine (VM) high availability, fault tolerance and VM live migration are used to ensure reliability of the workloads. Sophisticated backup and disaster recovery (DR) procedures are also put in place to handle an unlikely scenario of hardware failure. Traditional workloads require fault tolerant architectures and are built using enterprise-grade infrastructure components, which may typically include commercially supported hypervisors such as Citrix XenServer or VMware® vSphere™; high-performance storage area network (SAN) devices; traditional physical network routers, firewalls and switches; virtual local area networks (VLANs) (e.g., to isolate traffic among servers and tenants); etc.

In a cloud based compute, network and storage environment, compute resources are generally expected to be available from anywhere so that compute resources can be accessed from anywhere although provisioned only once. Such ‘anywhere access’ can be facilitated with global service profiles, which centralize logical configuration of workload deployed across the cloud network. Centralization enables maintenance of service profiles deployed in individual networks (e.g., UCS domains) from one central location. The global service profile facilitates picking a compute resource for the service profile from any of the available networks and migrating the workload associated with the service profile from one network to another.

Typically, when a global service profile is deployed from a central location, the service profile definition is sent to the management entity of a specific remote network. The management entity identifies a server in the network and deploys the service profile to the server, to instantiate the associated workload. The service profile definition that is sent to the management entity includes policy names of virtual network interface cards (vNICs) and virtual host bus adaptors (vHBAs), VLAN bindings, etc. The global service profile can be deployed to any of the compute resources in one of two ways: (i) direct assignment (e.g., to an available server in any of the networks remote from the central location); and (ii) assignment to a server pool in a specific remote network. The management entity of the chosen remote network configures the global service profile at the local level, resolving the VLAN bindings and other constraints associated with the service profile.

However, because certain resources can be constrained to a specific remote network, or even a subsection of a remote network (e.g., due to network connectivity constraints, mix of legacy and newer systems, etc.), the ‘access anywhere’ paradigm in a hybrid cloud environment can be generally impractical. Resources such as fibre channel (FC) based storage can be limited to a subset of the network where data can be accessed either on a primary or a secondary site. Consider, merely as an example, a 10 TB logical unit number (LUN) carved out on a storage array. As long as compute resources are bound to the storage array, the data stored therein can be accessed by the workload on the compute resources.

However, if the workload is migrated to another compute resource that does not have connectivity to the specific LUN, the workload cannot access the stored data and the migration will be unsuccessful. LUN replication in multiple domains may resolve the issue, however, current mechanisms require the network administrator to manually identify the specific compute resources having connectivity to the replicated LUNs, and migrate the workload to one of the identified workloads. Thus, the access anywhere paradigm is constrained by storage requirements. In a general sense, migration of workloads is affected by the hardware requirements specified for the workload.

Hence, when workloads are migrated across networks, accessibility to specific hardware resources may become a bottleneck. Hence, it may be desired to implement a management solution that can understand resource availability and constraints across networks and constraints and generate a migration sphere, wherein a specific workload can be migrated only to compute resources identified in the migration sphere for the workload, instead of migrating without resource availability knowledge, which can result in a non-functional system.

Communication system 10 is configured to address these issues (among others) to offer a system and method for computing migration sphere 30 of workloads 29 in a network environment. In various embodiments, migration spheres 30 can be generated based on static constraints or dynamic constraints. For example, in a FC based storage, migration sphere 30 may include compute resources 16 that can be accessed on a primary site, and another set of compute resources 16 that can access a replicated secondary site of the FC based storage.

In various embodiments, migration sphere 30 may be generated by a centralized application that oversees a plurality of management entities that manage disparate networks 12. The management entities may be embedded in, and execute from, appropriate network elements, such as fabric interconnects in respective networks 12. The centralized application may generate a list of compute resources 16 suitable for instantiation of a specific service profile 24. For example, the list may include computer resources 16 that can co-exist with specific storage resources 18 in a particular network 12. In view of additional network considerations such as load balancing and power requirements, workloads 29 may be suitably deployed on a subset of compatible compute resources 16 from the list; the subset of compute resources 16 comprise migration sphere 30.

Note that in some embodiments, each time a particular workload 29 is introduced into one of networks 12, its corresponding migration sphere 30 may be calculated and kept up-to-date (e.g., including changes in network conditions), for example, to provide administrators with effective information about a degree of high-availability in the network environment for potential workload migrations. Embodiments of communication system 10 can facilitate a fast, efficient and effective method to enable administrators to plan their workload deployments and migration by automatically making available information about compatible compute resources 16 in networks 12.

Such automatic migration sphere generation can cut deployment time and extensive manual inspection of resources in a massive data-center, before migrating or deploying workloads 29, with resulting better user experiences, effective deployments and service level agreement (SLA) requirements match. There are apparently no existing solutions that can compute information about available conducive compute resources 16 for workload deployment and use the information to effectively plan workload deployment in a scaled data center. In some embodiments, migration spheres 30 may indicate a green zone (e.g., compatible for workload deployment) and a red zone (e.g., incompatible for workload deployment) of specific workloads 29 in networks 12.

In various embodiments, service profile 24 can be generalized for multi-tenant environments. Each remote network 12 can be used by multiple tenants, each tenant using distinct portions of compute resources 16 in each remote network 12. In such scenarios, service profile 24 may be associated with a specific tenant, and migration sphere 30 includes only those compute resources 16 that can be accessed by the specific tenant. The centralized application managing resources and assignments across networks 12 can add a level of supervision that simplifies management and migration of workloads 29.

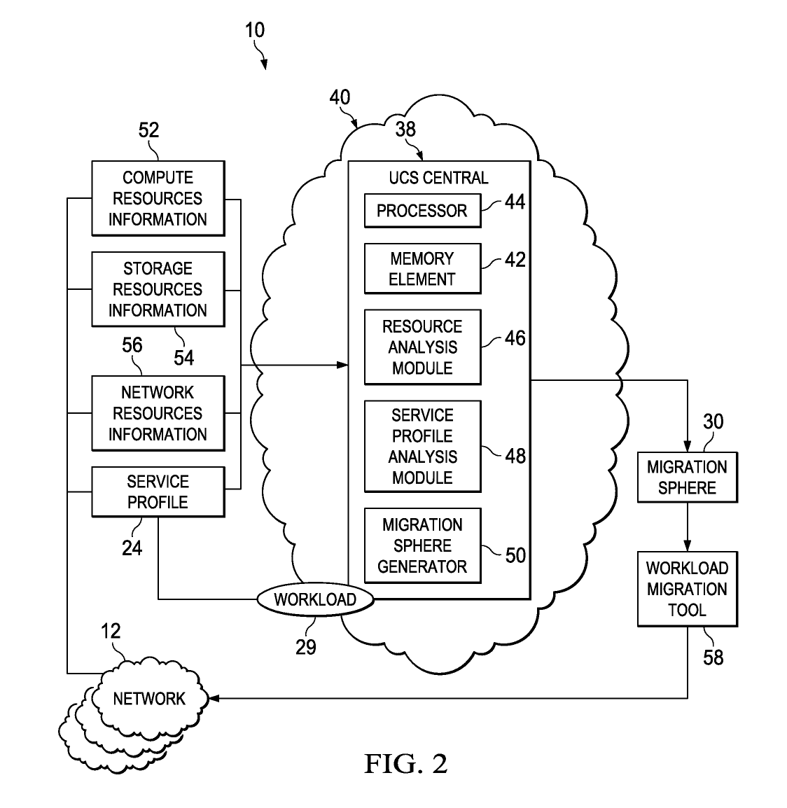

Turning to FIG. 2, FIG. 2 is a simplified block diagram illustrating example details of another embodiment of communication system 10. According to various embodiments, a virtual appliance (e.g., prepackaged as a VMware.ova or an ISO image) called unified computing system (UCS) Central 38, executing in network 40, receives network information from a plurality of remote networks 12. As used herein, the term “virtual appliance” comprises a pre-configured virtual machine image ready to execute on a suitable hypervisor; installing a software appliance (e.g., applications with operating system included) on a virtual machine and packaging the installation into an image creates the virtual appliance. The virtual appliance is not a complete virtual machine platform, but rather a software image containing a software stack designed to run on a virtual machine platform (e.g., a suitable hypervisor).

Remote networks 12 are separate and distinct from network 40. For example, remote networks 12 comprise network partitions in a data center; network 40 may comprise a public cloud separate from the data center. In another example, remote networks 12 may comprise disparate networks of a single enterprise located in various geographical locations; network 40 may comprise a distinct and separate portion of the enterprise network located, say, at company headquarters. Note that remote networks 12 comprise separate, distinct networks, and storage resources 18 in any one remote network 12 cannot be accessed by compute resources 16 in any other remote network 12.

In some embodiments, remote network 12 may be managed by separate distinct management applications, such as Cisco UCS Manager (UCSM), or distinct instances thereof. UCS Central 38 may securely communicate with the UCSM instances to (among other functions) collect network information, inventory and fault data; create resource pools of compute resources 16 and storage resources 18 available to be deployed; enable role-based management of resources; support creation of global policies, service profiles, and templates; enable downloading of and selective or global application of firmware updates; and invoke specific instances of UCSM to more detailed management.

In many embodiments, UCS Central 38 stores global resource information and policies accessible through an Extensible Markup Language (XML) application programming interface (API). In some embodiments, operation statistics may be stored in an Oracle or PostgreSQL database. In various embodiments, UCS Central 38 can be accessed through an appropriate graphical user interface (GUI), command line interface (CLI), or XML API (e.g., for ease of integration with high-level management and orchestration tools).

According to various embodiments, UCS Central 38 facilitates managing multiple networks 12 through a single interface in network 40. For example, UCS Central 38 can facilitate global policy compliance, with subject-matter experts choosing appropriate resource pools and policies that may be enforced globally or managed locally. With simple user interface operations (e.g., drag-and-drop), service profiles 24 can be moved between geographies to enable fast deployment of infrastructure, when and where it is needed, for example, to support workloads 29.

UCS Central 38 may include a memory element 42 and a processor 44 for performing the operations described herein. A resource analysis module 46 in UCS Central 38 may analyze the network information, comprising compute resources information 52 (associated with compute resources 16 in networks 12, for example, processor type, processor speed, processor location, etc.), storage resources information 54 (associated with storage resources 18 in networks 12, for example, storage type, storage size, storage location, etc.), and network resources information 56 (associated with other network elements in networks 12, for example, VLANs, vNICs, vHBAs etc). The network information can also include platform specific constraints, power budgeting requirements, network policies, network features, network load, and other network requirements.

A service profile analysis module 48 in USC Central 38 may analyze service profile 24 associated with a particular workload 29 to be deployed in one of remote networks 12. Service profile 24 may indicate compute requirements 26 and storage requirements 28 associated with workload 29. A migration sphere generator 50 may generate migration sphere 30 including substantially all compute resources 16 in plurality of networks 12 that meet at least compute requirements 26 and storage requirements 28 associated with workload 29, which may be successfully deployable on any one of compute resources 16 in migration sphere 30. Migration sphere 30 may be associated with service profile 24, which in turn may be associated with workload 29.

In various embodiments, generating migration sphere 30 can include generating a list of substantially all compute resources 16 across plurality of remote networks 12, analyzing compute, storage and network connectivity of compute resources 16 based on the network information, comparing compute requirements 26 and storage requirements 28 of workload 29 with the compute, storage and network connectivity of compute resources 16, and eliminating compute resources 16 from the list that do not meet at least compute requirements 26 and storage requirements 28 for workload 29, the remaining compute resources 16 in the list being populated into migration sphere 30.

In some embodiments, generating migration sphere 30 can further comprise eliminating compute resources 16 that do not meet network policies, network load, and other network requirements. For example, substantially all servers in a particular network 12 may be loaded to maximum capacity when workload 29 is introduced; in such a scenario, although compatible in other respects, compute resources 16 from that particular network 12 may not be included in migration sphere 30 for workload 29.

In various embodiments, migration sphere 30 can include compute resources 16 from different networks 12. A workload migration tool 58 may deploy or migrate workload 29 in networks 12 based on migration sphere 30. Workload 29 may be deployed on a specific compute resource 16 on a particular network 12 and migrated to another compute resource 16 on another network 12, both compute resources being included in migration sphere 30. Migration of workload 29 causes a change in the network information, and UCS Central 38 may update migration sphere 30 with the changed network information.

Turning to the infrastructure of communication system 10, the network topology can include any number of servers, hardware accelerators, virtual machines, switches (including distributed virtual switches), routers, and other nodes inter-connected to form a large and complex network. A node may be any electronic device, client, server, peer, service, application, or other object capable of sending, receiving, or forwarding information over communications channels in a network. Elements of FIG. 2 may be coupled to one another through one or more interfaces employing any suitable connection (wired or wireless), which provides a viable pathway for electronic communications. Additionally, any one or more of these elements may be combined or removed from the architecture based on particular configuration needs.

Communication system 10 may include a configuration capable of TCP/IP communications for the electronic transmission or reception of data packets in a network. Communication system 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 2 do not connote any type of hierarchy; the designations are arbitrary and have been used for purposes of teaching only. Such designations should not be construed in any way to limit their capabilities, functionalities, or applications in the potential environments that may benefit from the features of communication system 10. It should be understood that communication system 10 shown in FIG. 2 is simplified for ease of illustration.

The example network environment may be configured over a physical infrastructure that may include one or more networks and, further, may be configured in any form including, but not limited to, local area networks (LANs), wireless local area networks (WLANs), VLANs, metropolitan area networks (MANs), VPNs, Intranet, Extranet, any other appropriate architecture or system, or any combination thereof that facilitates communications in a network.

In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

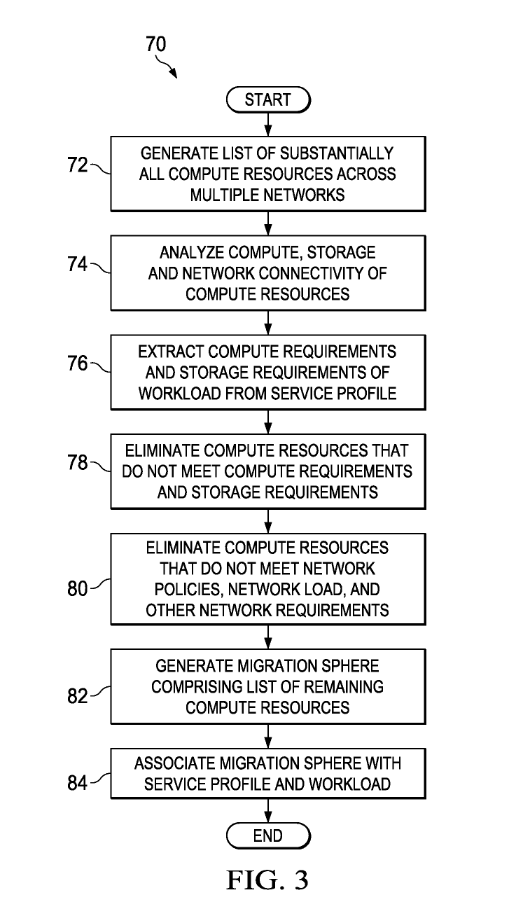

Turning to FIG. 3, FIG. 3 is a simplified flow diagram illustrating example operations 70 that may be associated with embodiments of communication system 10. At 72, UCS Central 38 may generate a list of substantially all compute resources 12 across multiple networks 12. At 74, UCS Central 38 may analyze compute, storage, and network connectivity of compute resources 16 in the generated list. At 76, UCS Central 38 may extract compute requirements 26 and storage requirements 28 of workload 29 from service profile 24. At 78, UCE Central 38 may eliminate from the list those compute resources 16 that do not meet compute requirements 26 and storage requirements 28 for workload 29. At 80, UCS Central 38 may further eliminate those compute resources 16 from the list that do not meet network policies, network load, and other network requirements. At 82, UCS Central 38 may generate migration sphere 30 comprising list of compute resources 16 remaining un-eliminated from the list. At 84, migration sphere 30 may be associated with service profile 24 and workload 29.

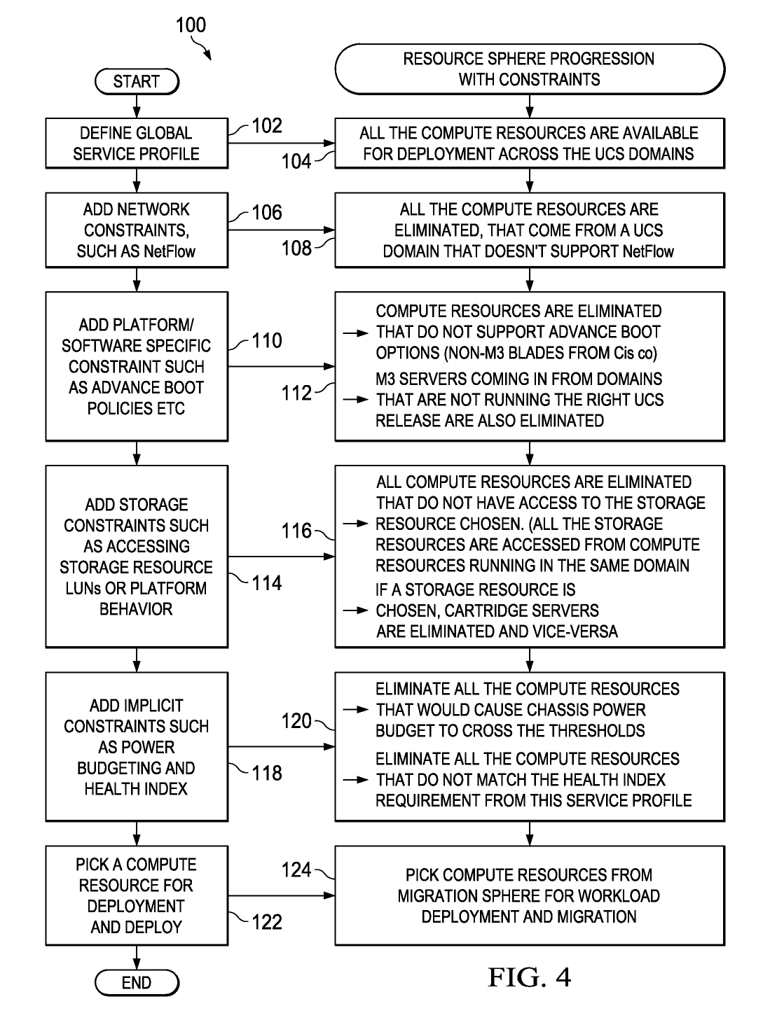

Turning to FIG. 4, FIG. 4 is a simplified flow diagram illustrating example operations 100 that may be associated with embodiments of communication system 10. At 102, UCS Central 38 may define a global service profile, which can include, at 102, substantially all compute resources 16 available for deployment across plurality of networks 12, comprising UCS domains. At 106, UCS Central 38 may add constraints, such as NetFlow, to prune the list generated at 102. The pruned list at 108 may eliminate compute resources 16 that do not support NetFlow (e.g., if a particular UCS domain does not support NetFlow, compute resources 16 from that UCS domain may be eliminated). At 110, UCS Central 38 may add platform and software specific constraints such as advance boot policies, etc. to further prune the list. The pruned list at 112 may eliminate compute resources 16 that do not support the platform and software constraints (e.g., non-M3 blades from Cisco may be eliminated as they do not support advanced boot options; M3 servers from UCS domains that are not running the right version of the management software (UCS release) may also be eliminated).

At 114, UCS Central 38 may add storage constraints such as accessing storage blade LUNs or platform behavior to further prune the list. At 116, the pruned list may eliminate substantially all compute resources 16 that do not have access to the chosen storage resources 18 (e.g., substantially all storage blades are accessed from compute blades running in the same domain). For example, if a storage blade is chosen, cartridge servers are eliminated and vice versa. At 118, UCS Central 38 may add implicit constraints such as power budgeting and health index, which may not necessarily relate to service profile 24 or workload 29 (e.g., they may be general network requirements, for example consistent with enterprise wide business goals) to prune the list further. The pruned list at 120 may eliminate compute resources 16 that would cause chassis power budget to cross a predetermined threshold; compute resources 16 that do not match health index requirement from service profile 24 may also be eliminated. At 122, workload migration tool 58 may pick a particular compute resource 16 for deployment and deploy workload 29 thereon; thus at 124, a particular compute resource 16 from migration sphere 30 may be selected for workload deployment and/or migration.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Note also that an ‘application’ as used herein this Specification, can be inclusive of an executable file comprising instructions that can be understood and processed on a computer, and may further include library modules loaded during execution, object files, system files, hardware logic, software logic, or any other executable modules. Furthermore, the words “optimize,” “optimization,” and related terms are terms of art that refer to improvements in speed and/or efficiency of a specified outcome and do not purport to indicate that a process for achieving the specified outcome has achieved, or is capable of achieving, an “optimal” or perfectly speedy/perfectly efficient state.

In example implementations, at least some portions of the activities outlined herein may be implemented in software in, for example, UCS Central 38. In some embodiments, one or more of these features may be implemented in hardware, provided external to these elements, or consolidated in any appropriate manner to achieve the intended functionality. The various network elements (e.g., UCS Central 38) may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, UCS Central 38 described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 42) can store data used for the operations described herein. This includes the memory element being able to store instructions (e.g., software, logic, code, etc.) in non-transitory media, such that the instructions are executed to carry out the activities described in this Specification. A processor can execute any type of instructions associated with the data to achieve the operations detailed herein in this Specification. In one example, processors (e.g., processor 44) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in communication system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’ Similarly, any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, communication system 10 may be applicable to other exchanges or routing protocols. Moreover, although communication system 10 has been illustrated with reference to particular elements and operations that facilitate the communication process, these elements, and operations may be replaced by any suitable architecture or process that achieves the intended functionality of communication system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method executing in a virtual appliance in a network, wherein the method comprises:
receiving network information from a plurality of remote networks;
analyzing a service profile associated with a workload to be deployed in one of the remote networks and indicating compute requirements and storage requirements associated with the workload; and
generating a migration sphere comprising compute resources in the plurality of networks that meet at least the compute requirements and storage requirements associated with the workload, the workload being successfully deployable on any one of the compute resources in the migration sphere.

2. The method of claim 1, wherein the network information includes compute resource information, storage resource information and network resource information in the remote networks.

3. The method of claim 1, wherein the network information includes platform specific constraints, power budgeting requirements, network policies, network features, network load, and other network requirements.

4. The method of claim 1, wherein generating the migration sphere comprises:
generating a list of substantially all compute resources across the plurality of remote networks;
analyzing compute, storage and network connectivity of the compute resources based on the network information;
comparing the compute requirements and storage requirements associated with the workload with the compute, storage and network connectivity of the compute resources; and
eliminating compute resources from the list that do not meet at least the compute requirements and storage requirements associated with the workload, wherein the remaining compute resources in the list populate the migration sphere.

5. The method of claim 4, wherein generating the migration sphere further comprises eliminating compute resources that do not meet network policies, network load, and other network requirements.

6. The method of claim 1, wherein the plurality of remote networks includes a first remote network and a second remote network, wherein the migration sphere includes a first compute resource in the first remote network and a second compute resource in the second remote network, wherein the workload is deployed in the first compute resource and migrated from the first compute resource to the second compute resource.

7. The method of claim 1, wherein the migration of the workload causes a change in the network information, wherein the migration sphere is updated with the changed network information.

8. The method of claim 1, wherein the remote networks comprise separate, distinct networks, wherein storage resources in any one remote network cannot be accessed by compute resources in any other remote network.

9. The method of claim 1, wherein each remote network is used by multiple tenants, each tenant using distinct portions of compute resources in each remote network, wherein the service profile is associated with a specific tenant, wherein the migration sphere includes only those compute resources that can be accessed by the specific tenant.

10. The method of claim 1, further comprising associating the migration sphere with the service profile.

11. Non-transitory tangible media that includes instructions for execution, which when executed by a processor associated with a virtual appliance in a network, is operable to perform operations comprising:
receiving network information from a plurality of remote networks;
analyzing a service profile associated with a workload to be deployed in one of the remote networks and indicating compute requirements and storage requirements associated with the workload; and
generating a migration sphere comprising compute resources in the plurality of networks that meet at least the compute requirements and storage requirements associated with the workload, the workload being successfully deployable on any one of the compute resources in the migration sphere.

12. The media of claim 11, wherein the network information includes compute resource information, storage resource information and network resource information in the remote networks.

13. The media of claim 11, wherein generating the migration sphere comprises:
generating a list of substantially all compute resources across the plurality of remote networks;
analyzing compute, storage and network connectivity of the compute resources based on the network information;
comparing the compute requirements and storage requirements associated with the workload with the compute, storage and network connectivity of the compute resources; and
eliminating compute resources from the list that do not meet at least the compute requirements and storage requirements associated with the workload, wherein the remaining compute resources in the list populate the migration sphere.

14. The media of claim 13, wherein generating the migration sphere further comprises eliminating compute resources that do not meet network policies, network load, and other network requirements.

15. The media of claim 11, wherein the plurality of remote networks includes a first remote network and a second remote network, wherein the migration sphere includes a first compute resource in the first remote network and a second compute resource in the second remote network, wherein the workload is deployed in the first compute resource and migrated from the first compute resource to the second compute resource.

16. An apparatus in a first network, comprising:
a virtual appliance;
a memory element for storing data; and
a processor, wherein the processor executes instructions associated with the data, wherein the processor and the memory element cooperate, such that the apparatus is configured for:
receiving network information from a plurality of remote networks;
analyzing a service profile associated with a workload to be deployed in one of the remote networks and indicating compute requirements and storage requirements associated with the workload; and
generating a migration sphere comprising compute resources in the plurality of networks that meet at least the compute requirements and storage requirements associated with the workload, the workload being successfully deployable on any one of the compute resources in the migration sphere.

17. The apparatus of claim 16, wherein the network information includes compute resource information, storage resource information and network resource information in the remote networks.

18. The apparatus of claim 16, wherein generating the migration sphere comprises:
generating a list of substantially all compute resources across the plurality of remote networks;
analyzing compute, storage and network connectivity of the compute resources based on the network information;
comparing the compute requirements and storage requirements associated with the workload with the compute, storage and network connectivity of the compute resources; and
eliminating compute resources from the list that do not meet at least the compute requirements and storage requirements associated with the workload, wherein the remaining compute resources in the list populate the migration sphere.

19. The apparatus of claim 18, wherein generating the migration sphere further comprises eliminating compute resources that do not meet network policies, network load, and other network requirements.

20. The apparatus of claim 16, wherein the plurality of remote networks includes a first remote network and a second remote network, wherein the migration sphere includes a first compute resource in the first remote network and a second compute resource in the second remote network, wherein the workload is deployed in the first compute resource and migrated from the first compute resource to the second compute resource.
